(19) United States
(12) Patent Application Publication
(10) Pub. No.: US 2010/0193260 A1
(43) Pub. Date: Aug. 5, 2010

(54) Electric car with maximized solar assist

(76) Inventor: Benjamin Freeman, Philadelphia, PA (US)

Correspondence Address: Benjamin Freeman, 6045 Daniel St, Philadelphia, PA, 19144, US

(21) Appl. No.: 12/322,565

(22) Filed: Feb. 3, 2009

(51) Int. Cl. B60K 16/00; B60L 8/00

(52) U.S. Cl. 180/2.2

(57) ABSTRACT

The present invention is an electric car with a maximized solar panel assist. Since batteries are normally charged at night while solar energy is created during the day, this system creates an almost continuous flow of electricity to the batteries. Since the weight and cost of the batteries are the main handicap for electric cars and a continuous flow of electricity minimizes the need for a large and expensive battery system, this is the most logical way to build a viable electric car.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### SEQUENCE LISTING

Not Applicable

### BACKGROUND OF THE INVENTION

1. Field of the Invention

Because of the expense, political and ecological problems involved with importing oil, the US, and the world, needs electric cars. In fact, the only fundamental impediment to electric cars becoming more important than those with internal combustion engines is the difficulty of building a reasonably priced electric car (or a reasonably priced gas/electric hybrid with the electric motor being the dominant one) that has the range people want. It is also worth noting, however, that a “plug in” pure electric car or a hybrid whose dominant electric motor only relies on plug in electricity and electricity indirectly generated by the internal combustion engine is not so much better than a standard car in terms of global warming. This is because most “plug in” electricity is generated by fossil fuels. Solar power, on the other hand, is both free and does not cause global warming or other ecological problems. Therefore, I believe that the car of the future will have a dominant electric motor drive train whose primary source of power is solar.

The present invention is in the field of electric cars. Primarily because electric cars without a solar power supplement do not have enough range to satisfy the average driver and secondarily because plug in electricity is produced by fossil fuels, the present invention supplements the use of plug in electricity with the use of electricity generated by solar collection devices. While many more traditionally minded car designers have considered solar power supplements, they are so attached to traditional car design that they refuse to accept the fundamental reality of solar technology. Because of the huge power requirements to move a vehicle at speeds which drivers are used to, no solar collection device technology makes it possible to generate a significant percent of the cars energy needs unless the size of the solar panels is much larger than the size of the car itself. Since the whole point of having oversized solar panels is to make it possible for the limited output of solar collection devices to generate enough power to contribute a significant percentage of the cars power requirements, an electric car with a significant solar panel supplement must be designed to be as lightweight and aerodynamic as possible. Only in this way will we reduce the power requirements low enough that solar power can potentially provide most of the car's power.

While oversized solar panels on a car with minimal power requirements are the key necessary pre-conditions to generating a significant percent of a cars power through the use of solar panels, there are many other considerations for creating a car along these lines that would appeal to large numbers of people. Firstly, the car shouldn't be so small and lightweight that it is unable to carry a few passengers and the driver in reasonable comfort. Secondly, the oversized solar panels cannot interfere with egress. Thirdly, they must not create the possibility of the car being tipped over by a heavy gust of wind. Fourthly, a series of indicators and related devices must be incorporated into the cars design to facilitate the maximization of solar power output. Fifthly, the overall footprint of the car and the deployed size of the solar panels when it is being driven must be small enough that it can fit on a traditional road. But the most important and difficult problem for all types of electric cars to overcome is that one usually can't continuously travel any further than the battery pack will allow. Because of this problem, cars with internal combustion engines will continue to be bought by those who regularly travel long distances. However, even selling electric cars to those who only occasionally make long trips requires us to find some way to allow the car to occasionally drive longer distances. To a limited extent, solar power allows one to travel somewhat further than the maximum range of the battery pack. While some hope that this range issue will be solved by the invention of a method for fast charging batteries in minutes, there is no research which suggests that it will be possible for an electric cars' batteries to be recharged in a few minutes. But one can fulfill the underlying objective of making it possible for a car to continue driving after its batteries are depleted by exchanging depleted batteries for recharged batteries at a battery exchanging station. This would be similar to the way that one exchanges depleted propane tanks for recharged propane tanks. While there are few battery exchanging stations today, they would probably appear if electric cars were built that were made for easy exchange of the batteries. Hence, the sixth requirement for making an electric car that people will eventually see as equivalent to a car with an internal combustion engine is for the car to be designed so that the battery array can be changed quickly, easily and inexpensively. The seventh possible advantage of a viable electric car is for it to compensate for its light weight by including safety features not available on standard cars. The eighth and last requirement for manufacturing an electric car for the mass market is that meeting the other seven requirements must not raise the car's price far above that of an average car with an internal combustion engine. Precisely because of this last point, most of my suggested features are not super-high tech solutions. In fact, one of the related art examples was included specifically to suggest why high tech solutions will often drive the cost of the vehicle and its use beyond what the average driver is willing to pay.

In summary, I believe that my using the holistic approach of combining a variety of not especially high tech features as outlined in the present invention is the first and only existing example of a car that meets most of these varied requirements.

2. Description of Related Art

The following is art representative of what is published in the field of solar energy powered cars.

The publication of IEEE SPECTRUM ONLINE, June 2007, by Glenn Zorpette entitled “The Sun Race Gets Real” discloses a photograph by Hans-Peter Van Velthoven of the Delft University solar racer discloses solar car that has a single solar panel, aerodynamically efficient body design and a range of 3,000 Km. However, it lacks solution to the problems of carrying multiple passengers, ease of getting into and out of the passenger compartment or extended driving range at night or during compromised sun exposure.

U.S. Pat. No. 5,680,907 to inventor Weihe discloses a conventional IC engine driven car equipped with a solar panel on the roof. A multiple passenger compartment and access are well provided for. However, this approach to reducing green house gasses does little to reduce wind drag and has a very limited speed or driving range if solar power alone is utilized.

U.S. Pat. No. 4,141,425 to inventor Treat discloses a solar powered car that has solar panels on the hood roof and trunk, a multiple passenger compartment and good passenger accessibility. However, the disclosure of inventor Treat lacks a solution to the problems of reducing wind drag, and an extended range of travel.

Published Patent Application US 2007/0261896 to inventor Shaffer et al. discloses a solar powered car with a multiple passenger compartment good passenger accessibility. However, the disclosure of inventor Shaffer et al. lacks a solution to the problems of wind drag, driving range during periods of limited sunlight or extended trip driving range.

Like the present invention, a reissued patent given to Mr Desert (number 31156) focuses on a very thin vehicle. However, this patent seems to be aiming at a long, almost buslike, vehicle. Such a large vehicle would not be able to use a lower horsepower and lower amp draw motor because it would weigh so much. Furthermore, it would never fit in a standard parking space. Most importantly, his patent never made the additional suggestion to use the extra space along the sides of a thin vehicle for solar panel overhangs.

Published U.S. Pat. No. 5,951,229 (inventor Hammerslag) describes a battery charging and transfer system for electrically powered vehicles. Not only is to too high tech and complex to be produced at a reasonable price, but the mechanism required takes an enormous amount of space. Hence, building cars designed to accommodate this battery exchanging system is a dead end because the battery exchanging stations will have to charge so much that consumers would find it less expensive to buy and use a car with an internal combustion engine.

While there is related art which has features similar to many of my individual features, there is no related art which singly or in combination fulfills the underlying requirements of creating an affordable electric car that can fulfill the driving requirements of an average driver nearly as well as a car with an internal combustion engine. Since these six examples are only a very small percentage of the patents, patent applications, internet suggestions and actually constructed vehicles that I and my patent agent (whose background is in engineering rather than law) have researched, I think it is fair to say that any researcher will also find that no one else has come up with an equally viable electric car design. More specifically, I would say that no one else has come up with an affordable electric car with the range of the present invention that can fulfill most of the other requirements that would make the electric car as desirable as a similarly priced car with an internal combustion engine.

In fact, many teams of designers and individuals have been trying to find a viable replacement for the internal combustion engine. Many of these teams consist of a variety of well trained experts with complementary skills backed by major research dollars. Since none of these individuals or groups has come up with any other method for creating an affordable electric car that can fulfill the driving needs of an average driver, it must not be obvious to a person with a reasonable appreciation of the art how this could be done. Hence, my holistic approach of combining a variety of features that include many which others have used and other low tech ideas must be original, different and important enough to deserve the protection of a patent.

### BRIEF SUMMARY OF THE INVENTION

The present invention is an extended range solar powered car for eliminating the emission of green house gasses and therefore reducing the threat of global warming.

The preferred embodiment provides for a body that includes a compartment for seating the driver and passengers. Because it would only be about forty inches wide, the driver is seated in the front of the passenger compartment and the passenger seats are located behind the driver, one behind the other. The body also includes a trunk or cargo area and one or two equipment compartments for housing batteries (or other energy storage systems), motors (called prime movers in the claims) and/or system controls. These would include at least three indicators (showing the charge of the energy storage systems, the amount of energy coming from the solar collection devices and a compass like sun finder to help orient and align the solar panels to maximize solar output) and controls to position the solar roof as required by the driver. The preferred embodiment also provides for these indicators and controls to be wirelessly accessed by the driver when he is not in the car. The purpose of this is to allow a driver working, shopping, visiting or staying nearby to see if it is necessary to reposition the car or solar panels to maximize solar power output because of changes which have occurred while they are parked

The reason that the preferred embodiment is a thin car is that the wind drag of a vehicle is basically a function of the width of the front leading edge of the vehicle.

The preferred embodiment also provides for three or more wheels, normally four. The wheels support the car from the driving surface, allow the car to move with reduced rolling resistance and in most cases provide a means for transmitting the propulsion force that moves the car forward or in reverse.

At least one of the wheels receives power from the prime mover, normally an electric motor that produces torque and moves the car against the frictional resistance between the wheel and the driving surface.

In this prime embodiment, there will also be regenerative braking which creates energy as it slows the car down. To maximize safety, however, regular braking will also be provided.

When the car is parked, the solar collection roof will always be much larger than the car itself. Because people park far more time than they are actually driving, having the solar collection area larger than the car when it is parked is the key to maximizing solar output in order to guarantee that solar power can provide most of the energy for the average user. However, there will be two variants of the prime embodiment of this invention based primarily on the size of the solar roof when the car is driving. In what I call the first variation, the solar collection roof will always stay the same size so it will extend beyond the body of the car even when the car is being driven. To help stabilize a vehicle of this type when it is moving, the wheel bases for both sets of wheels will be significantly wider than the width of the forty inch wide box where the passengers are seated. There will be struts coming up from the wheel base to help support this extended solar roof. These struts can become taller or shorter depending on what is required as the solar roof itself is moved up or down or tilted. Furthermore, there will be an outside perimeter (see FIG. 4) which has a sensor which sets off air bags coming out of the car in case of a side impact collision. Such a system would make the vehicle safer for side impact collisions than anything which the car companies or NHTSA contemplates.

In the second variant, the solar roof will be segmented and fold up when the car is driving so that only a small area of solar collection devices will lie on top of the car roof (generally facing upward towards the sun) when the car is being driven. The drawings depict six of the myriad ways this could be done. Since the solar roof will not extend beyond the car body while the car is being driven, neither of the wheel sets on this type of car would need to be any wider than the inner box which holds the driver, riders and drive mechanisms. Unless one decides to have a wider wheel base anyway, this variant will not have an outside perimeter to help protect the driver and riders from side impacts.

While the first variant will be safer in terms of a side impact collision, it will be less stable and more prone to tipping than the second variant in cases of high cross winds while the car is being driven. However, the first variant will be easier to use and maintain since constant opening and closing of the segmented solar roof while the car is parked will probably create maintainence problems. Although the second variant might cost more due to the cost of segmenting the solar roof and being able to open and close the segments as desired, it will look more like a regular car when driven and, therefore, will probably be seen as more stylish and traditional. Part of the reason that the second variant could look more like a regular car is that there is less necessity to make the box where the riders are seated as thin. For instance, the second variant could be built as a fifty five inch wide vehicle and achieve the result of having twice as wide of a solar panel roof when parked by spreading the solar panels to a hundred and ten inches. While doing that might create complications in finding an appropriate parking spot to spread the roof, one could (partly) solve that problem by having the entire roof mechanism move upward to a height above other nearby vehicles. By comparison, the fixed (but tiltable) roof of the first variant could not be wider than a car lane and, therefore, making the inner box half as wide would lead to a maximum width of about forty inches.

Either variant can use a solar collection device as the hood of the car with the energy from that smaller panel feeding the auxiliary systems instead of the motor. Since the segmented variant could allow the roof to extend over the hood when the car is parked, it is more probable that the solar panel hood would be used in conjunction with the first variant.

The energy created by the solar collection device will feed the batteries or other energy storage devices. However, the batteries will still get supplemental power by being plugged in like a non-solar electric vehicle.

The claims section of this patent mentions that the batteries will be placed for easy removal. In either variant of the prime embodiment, this will be done by setting the batteries on a tray placed in the very back of the vehicle which is set on the car body in such a way that the type of tynes used in forklifts can remove the entire tray with the batteries still affixed to the tray. The primary point of doing this is to allow for a discharged energy storage (or battery) array to be replaced quickly with a fully charged one affixed to an identical tray. This would allow the driver to continue on their way in the same way that a driver can fill his tank with gas and continue on his way. Obviously, the electric connection between the batteries and the remainder of the car must be set up so that a non-electrician can easily disconnect them when a discharged battery array is being removed and then reconnect the newly installed fully charged battery array to the car's electrical system.

Basically, we have designed an electric car with two slightly different variants whose common purpose is to maximize the range of an electric vehicle and minimize its use of fossil fuels. Nonetheless, someone could retain all our features and combine them with an internal combustion engine in a hybrid type vehicle. While this would totally solve the range problems of electric vehicles, it would not be as good in terms of global warming, purchase price, repair costs or the oil import issue. However, the use of a large solar roof (especially when the car is parked) to generate electric power combined with the normal hybrid system for generating electric power as a byproduct of using the internal combustion engine could create a hybrid where the electric motor was used more than half of the time and the use of fossil fuels would be less than any car on the road today. Such a car could be primarily electric even without having a plug in capacity. Since the day to day complications of plugging ones car in is a primary complaint of consumers regarding all types of electric vehicles, this type of hybrid might actually be more salable (although less good for ecological and oil import reduction) than our prime embodiment.

As you may have noticed, I use the words “solar panel” and “solar energy collection devices” almost interchangeably. That is because this same system would work just as well if one used a solar collection device (like the paint on or thin film devices that are just now coming to market) that is not designed exactly like todays solar panels. Similarly, I use the word “battery” and “battery array” when I technically mean “electricity storage device.” While most types of electricity storage devices might work, I often use the word battery because that is the best known type of electricity storage device.

We believe that the combination of features included increases the range of the car without creating a car whose weight, cost or difficulty of using and repairing creates more total disadvantage than a gas driven car. Although the controls, recharging and other features make it slightly more difficult to use, the lowered amount of parts and repair costs (electric cars have far less parts than cars with internal combustion engines) will compensate. In the end, the maintainence and other difficulties associated with owning an all electric version of our car will usually be less than the maintainence and other difficulties associated with owning a normal gas driven car. Especially if one assumes that a network of battery changing stations will eventually be built as many are already planning for, these features convert an electric car from a specialty vehicle for those who only drive short distances or who are willing to spend large sums of money for purely moral purposes into practical cost effective vehicles.

This patent demonstrates that one needs a holistic approach to build an electric car with a maximized solar assist made to be used on the roads and highways and sold for a price that regular family can afford. While no individual part of this patent involves extraordinarily complex or unique science, the key to the ability to build an electric car that can compete in price, value and range with a gas or hybrid car is to combine a group of comparatively low tech (and therefore, not very expensive) systems so that “the whole is greater than the parts.”

### BRIEF DESCRIPTION OF THE SEVERAL VIEWS OF THE DRAWING(S)

FIG. 1: Is a side view of the variant with the non-segmented solar roof and the hood being used to collect solar energy for the auxiliary systems. In this side view, the driver is away from the car and is pictured as using his wireless access to control the roof position.

FIG. 2: Is another side view of the same variant of the same vehicle. However, the driver is entering the car after tilting the solar panel roof so that the side he is entering on is high enough for him to get in the car without ducking.

FIG. 3: Is a side view of the same variant with three people seated in the car as it is being driven Unlike the first two figures which are angled side views, this one is a head on side view. It is like a picture that is taken in a way that it shows the side of the vehicle with the outer layer taken off.

FIG. 4: Is a top view of the same vehicle with the solar roof removed and no driver or passengers so that we can better see the lower part (underside) of the vehicle.

FIG. 5: is a back view of the same vehicle which primarily was included to show how forklift type tynes could fit in the space depicted and quickly replace a depleted battery array with a fully charged one. While figures one through five depict the first variant of an all electric prime embodiment, pages six through nine focus on the second variant of the all electric prime embodiment of this car.

FIG. 6: depicts the second variant of the present invention with the solar roof closed

FIG. 7: depicts the same car as figure six with the solar roof half opened.

FIG. 8: depicts the roof of the same car completely opened. Because it is a top view and the totally opened roof is larger than the car, one doesn't see the car at all

FIG. 9: Depicts a different style of solar roof (a sliding roof) totally closed

FIG. 10: Depicts the same style of roof as number 9 when it is opened.

FIG. 11: Depicts a different style of roof than FIGS. 9 and 10. This closed variant of the fold out roof has three parts.

FIG. 12: Depicts the same style of roof as FIG. 11. In this case, however, the fold out roof is totally open

FIG. 13: Depicts a similar style fold out roof as in FIGS. 11 and 12. In this figure, the three parts for the roof are folded down so one could say that the roof is closed.

FIG. 14: Depicts the same roof as in FIG. 13. However, it is opened. As one notices, it does not open flat (as does the similar roof in FIGS. 11 and 12)). Instead it is opened to maximize the amount of sun that it gets. One could call it a “sun seeker” roof.

FIG. 15: Is a solar roof that consists of two sliding roofs (each one being similar to the roof depicted in FIGS. 9 and 10). However, the sliding solar roofs are themselves mounted in a teepee style.

FIG. 16: is the same solar roof setup in FIG. 15. However, the sliding roofs are open. They are also tilted so as to point towards the sun.

### INDEX OF DRAWING REFERENCE NUMBERS

1—body

2—Drive battery

3—rear door

4—Accessory Battery

6—Drive Motor

8—Speed Control

10—Wheels

12—Seats

14—Solar roof panel

16—Hood solar panel

18—Tilt mechanism

20—Support

22—Sensor Display

24—communicator

26—Display

28—Windshield

30—slots for forklift tynes to fit

32—Side Bumpers

34—sensors for air bags

36—hinge connections

38—driver

40—sliding mechanism

42—mechanisms that might allow a solar roof to hinge outward

### DETAILED DESCRIPTION OF THE INVENTION WITH REFERENCE TO DRAWINGS

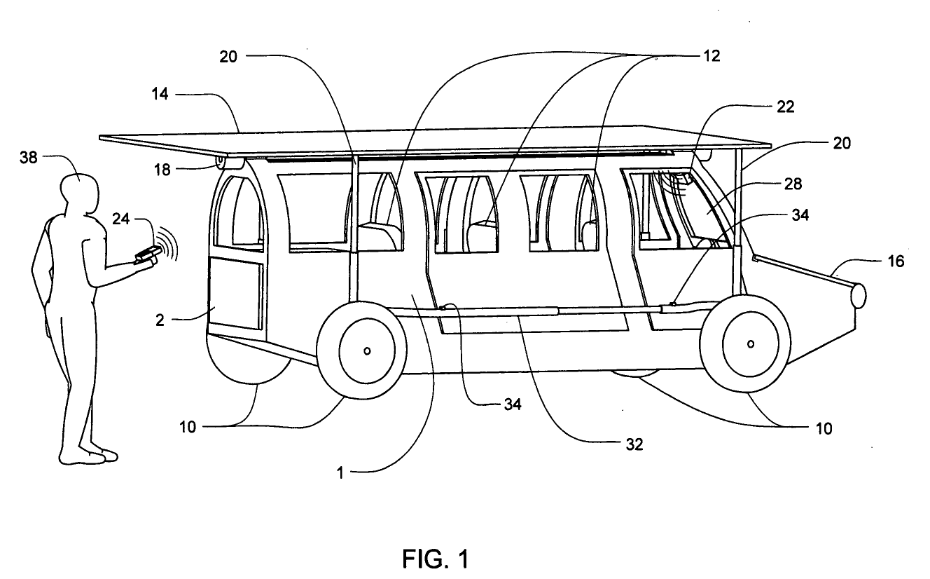

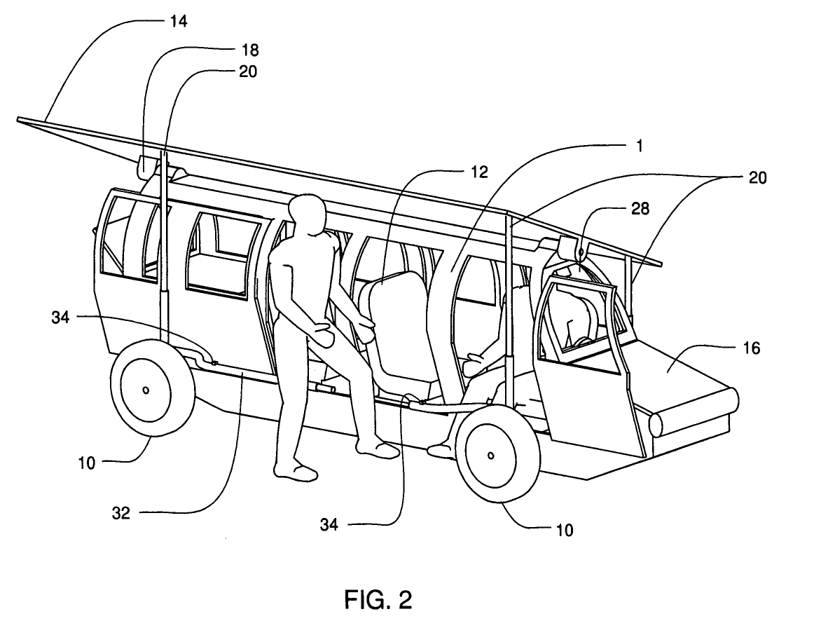

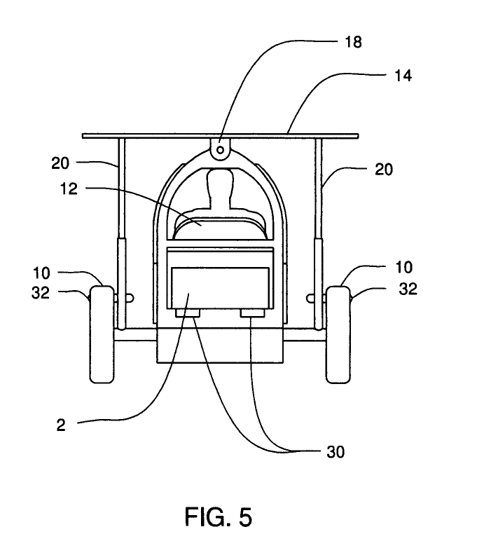

Referring to FIGS. 1 and 2, the body 1 is supported by the four wheels 10. Located where a hood would normally go on body 1 is the hood solar panel 16. Located on the roof of the body 1 is the solar panel roof 14. Located near the front of the body 1 on the inside near the top of where the windshield 28 is located are the sensor displays 22. Figure one only depicts how the sensor displays 22 can be wirelessly accessed by the communicator 24 that the driver 38 is holding. Between the wheels are side bumpers 32. Mounted on the side bumpers are sensors 34 to tell if the vehicle has suffered a side impact collision 34 which could set off outside air bags. Coming up from the side bumpers 32 are supports 20 which connect with and help support the solar panel roof 14. As you can see by comparing the length of these supports 20 in the figures one and two, these supports 20 can move up and down as the solar panel roof 14 moves up and down. Under the solar panel roof 14 near the back of the car are tilt mechanisms 18 to move the solar panel roof (comparing their positioning on figure one and two lets you see how they can be moved). Only pictured on figure one is a back door 2. As you will see when we discuss FIG. 5, this door is the access for easy removal of the batteries.

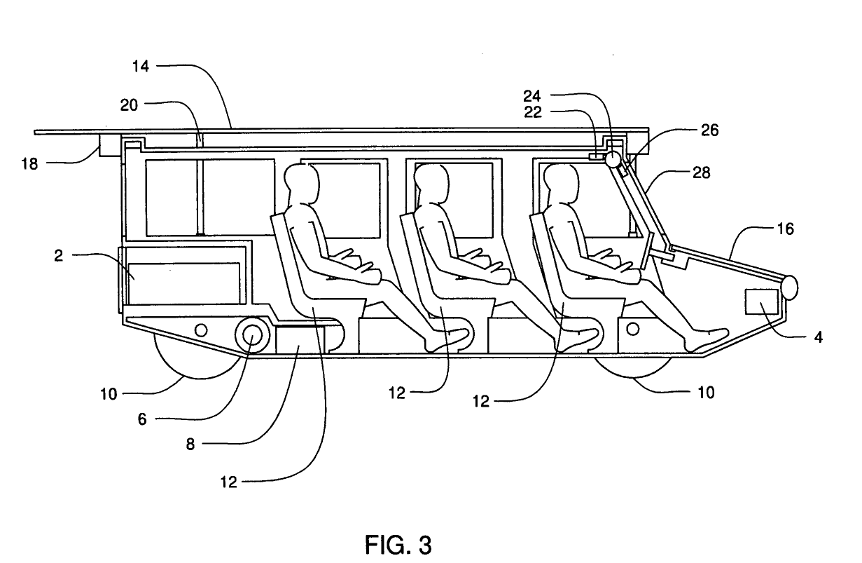

Referring to FIG. 3, which is essentially a side view cutaway of figure one and two, the seats 12 where the driver and passenger sit are lined up one behind the other. Behind them are the speed controller 8 and the motor 6. In the very front under the hood solar panel 16 is the battery to power the accessories 4.

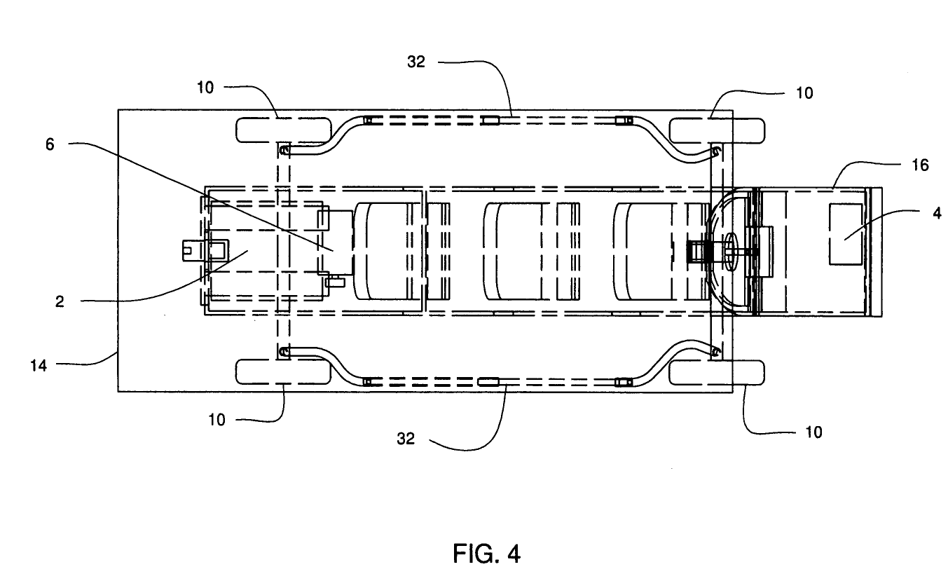

Referring to FIG. 4, everything depicted has already been described in figures one through three except that the location of the energy storage system 2 is shown.

Referring to FIG. 5, the batteries or energy storage system 2 are on top of a plate which is mounted in such a way that opening slots 30 exist for forklift type tynes to fit in and remove the battery array 2.

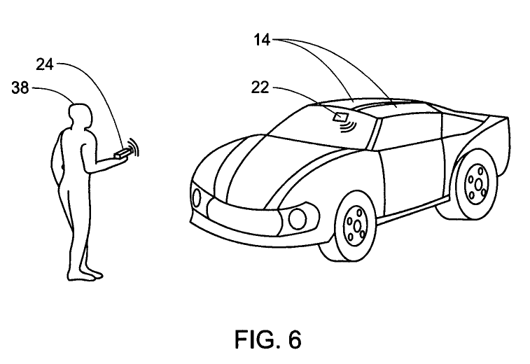

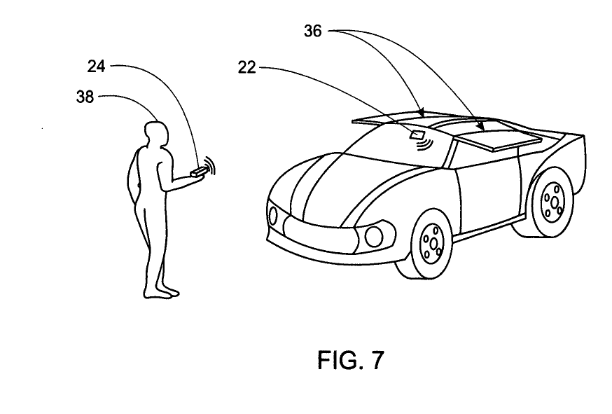

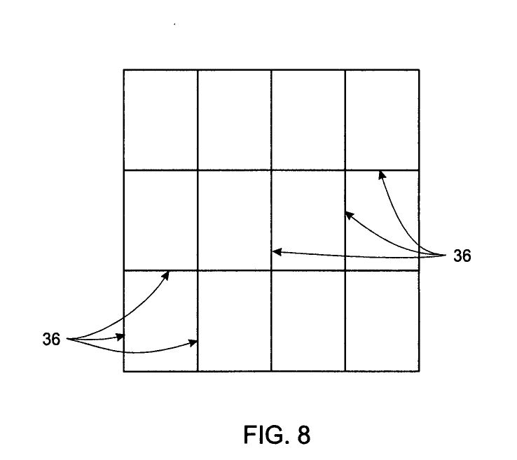

Referring to FIGS. 6, 7 and 8. These three drawings represent the same car with the solar panel roof 14 in different positions. In the first drawing (FIG. 6) the solar roof 14 is closed and its size is minimized. In the second drawing (FIG. 7) the solar panel roof is opened partway. It opens by use of hinges 36. As we see, the driver 38 is using a communicator 24 to find out what the sensor display 22 tells. He does this while he is away from the car so that he can make an informed decision about whether to make changes in the cars position or the positioning of the solar roof. In the third drawing (FIG. 8), we see how there are enough hinges 36 to open all twelve of the segments of the solar roof into a roof that is much larger than the unpictured car below.

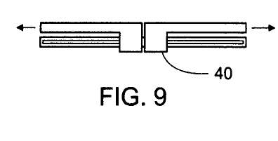

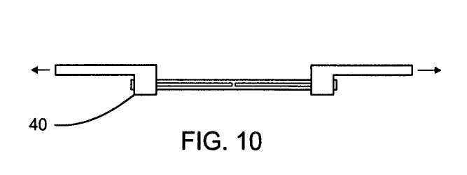

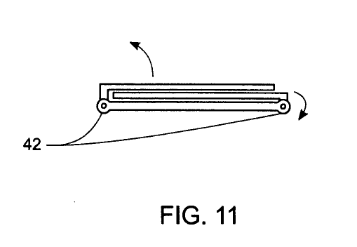

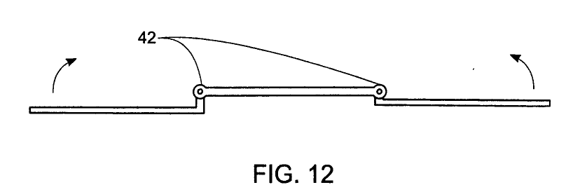

Referring to FIGS. 9 and 10. We see that the sliding mechanism 40 allows a solar panel roof to easily double in size. The unopened roof is depicted in FIG. 9 while the open roof is depicted in FIG. 10 Referring to FIGS. 11 and 12. These two drawings of the same roof show it closed (in FIG. 11) and opened (in FIG. 12). As we can see, the mechanism that allows the solar roof to hinge outward, 42, works in such a way that the size of the roof can triple

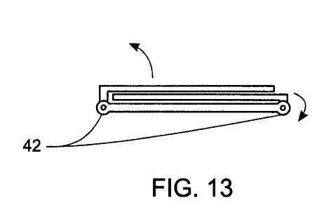

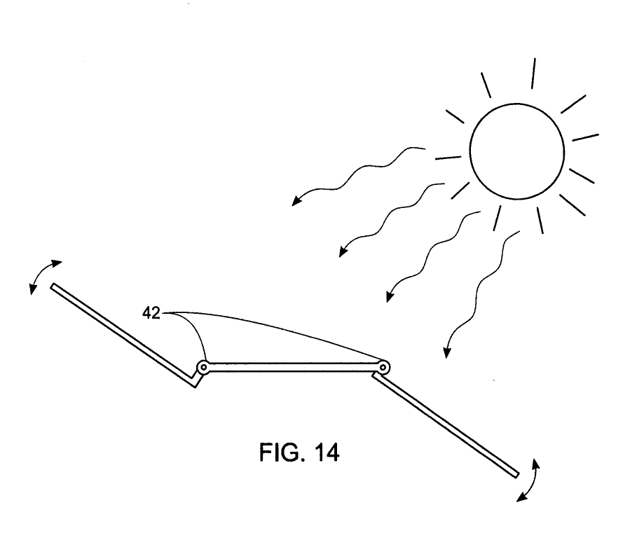

Referring to FIGS. 13 and 14. While FIG. 13 appears to depict the same roof closed as FIG. 11, when one sees this roof in the opened version (FIG. 14), one sees that there is a key difference. In this case, the roof does not open flat. Instead it opens in such a way that it angles in the direction of the sun to maximize solar output

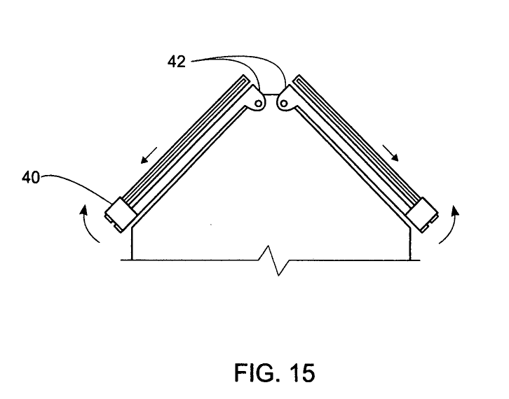

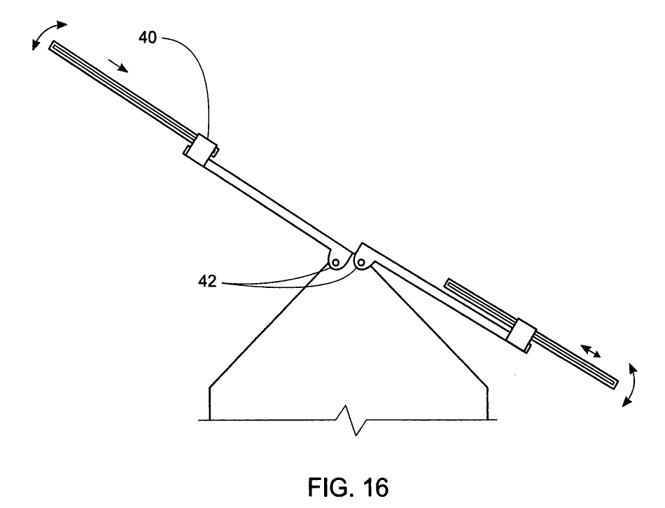

Referring to FIGS. 15 and 16. In this case, two sets of solar roofs with sliding mechanisms, 40, are themselves set in a teepee style so that both sets can double in size. As compared to all the other roofs depicted in the other figures, this roof has the maximum potential size since it angles outward on both sides of the car. When it is opened, we can see that the teepee is used so that all of the opened segments point in the same direction, i.e., towards the sun

I claim:

1. An extended range solar vehicle, comprising:
a body
three or more wheels;
at least one of the three or more wheels receiving a power from a prime mover;
at least one energy storing device for powering the prime mover;
one or more solar energy collecting devices for recharging the at least one energy storing device;
at least one recharging device for recharging at least one energy storing device from a second electrical source in addition to the one or more solar collecting devices;
one or more of the energy storing devices positioned and equipped for rapid exchange for extending the driving range of the vehicle;
a first indicator of the useable energy stored in the one or more energy storing devices;
a second indicator of the energy being converted into electricity by the one or more solar energy collecting devices;
wherein the one or more solar energy collecting devices is located over the head of at least one of the driver or passengers;
wherein the widest dimension across the one or more solar collecting devices exceeds the width of the wheel base;
wherein the wheel base exceeds the width of the body,
wherein the physical inclination of the one or more solar energy collecting devices can be readily altered;

2. The vehicle of claim 1, further comprising:
one or more solar collecting devices located below an eye level of at least one of the driver or passenger;

3. The vehicle of claim 1, wherein:
the one or more solar collecting devices located below an eye level of at least one of the driver or passenger supplies at least a portion of the energy used to power accessories such as lights, environmental devices or safety related devices.

4. The vehicle of claim 1, further comprising:
one or more collision sensors;
one or more air bags that deploy outside of the body;

5. The vehicle of claim 1, further comprising:
a removable structure that holds the one or more energy storing devices together and a quick disconnect electrical connection between the vehicle and one or more energy storage devices;

6. The vehicle of claim 5, further comprising:
at least one passage adjoining the removable structure for lifting by a tyne or fork of a lift;

7. The vehicle of claim 1, further comprising:
a regenerative braking system

8. The vehicle of claim 1, further comprising:
a third indicator of the position of the vehicle relative to one of the position or path of the sun;

9. The vehicle of claim 8, further comprising:
at least one of the first, second or third indicators communicating wirelessly to a remote receiver;

10. An extended range solar vehicle, comprising:
a body
three or more wheels;
at least one of the three or more wheels receiving a power from a prime mover;
at least one energy storing device for powering the prime mover;
one or more solar energy collecting devices for recharging the at least one energy storing device;
at least one recharging device for recharging at least one energy storing device from a second electrical source in addition to the one or more solar collecting devices;
one or more of the energy storing devices positioned and equipped for rapid exchange to extend the driving range of the vehicle;
an indicator of the useable energy stored in the one or more energy storing devices;
an indicator of the energy being converted by the one or more solar energy collecting devices;
wherein the one or more solar energy collecting devices is located over the head of at least one of the driver or passengers;
wherein the one or more solar collecting devices can be readily expanded to a width that exceeds the width of the wheel base and the width of the body of the car;

11. The vehicle of claim 10, further comprising:
one or more solar collecting devices located below an eye level of at least one of the driver or passenger;

12. The vehicle of claim 11, wherein:
the one or more solar collecting devices located below an eye level of at least one of the driver or passenger supplies at least a portion of the energy used to power accessories such as environmental, safety or a convenience devices;

13. The vehicle of claim 10, wherein:
There is regenerative braking,

14. The vehicle of claim 10, wherein:
the physical inclination of the one or more solar energy collecting devices can be readily altered;

15. The vehicle of claim 10, further comprising:
a removable structure that holds the one or more energy storing devices together;

16. The vehicle of claim 15, further comprising:
at least one passage adjoining the removable structure for lifting by a tyne or fork of a lift;

17. The vehicle of claim 16, further comprising:
a quick disconnect electrical connection between the vehicle and the one or more energy storing devices;

18. The vehicle of claim 10, further comprising:
a third indicator of the position of the vehicle relative to one of the position or path of the sun;

19. The vehicle of claim 10, further comprising:
at least one of the first, second or third indicators communicating wirelessly to a remote receiver;

20. the vehicle of claim 10, further comprising, a mechanism to raise the height of the solar panel roof with respect to the ground.
